(19) United States
(12) Patent Application Publication
(10) Pub. No.: US 2007/0106688 A1
(43) Pub. Date: May 10, 2007

(54) Network-based data feedback processing method and system

(75) Inventors: Wen-Yi Chang, Taipei (TW); Acky Tang, Shangahai (CN)

Correspondence Address: EDWARDS & ANGELL, LLP, P.O. BOX 55874, BOSTON, MA, 02205, US

(73) Assignee: Inventec Corporation, Taipei (TW)

(21) Appl. No.: 11/258,689

(22) Filed: Oct. 25, 2005

(51) Int. Cl. G06F 17/00

(52) U.S. Cl. 707/104.1

(57) ABSTRACT

A network-based data feedback processing method and system is proposed, which is designed for use in conjunction with a network system, and which is characterized by the capability of feeding the data stored in the database of a material dispatching management system on a data server on a remote side back to an ERP management system on a business-side server on a local side, for the purpose of allowing all the related working personnel of a business organization, such as purchase personnel, inventory management personnel, accounting personnel, and so on, to inquire into the feedback data via their own ERP management system. This feature can help enhance the efficiency of custom-related works in the enterprise.

### BACKGROUND OF THE INVENTION

1. Field of the Invention

This invention relates to network-based information technology, and more particularly, to a network-based data feedback processing method and system which is designed for use in conjunction with a network system, such as Internet, an intranet system, an extranet system, or a combination thereof, for providing a network-based data feedback processing function that allows all the related working personnel of a business organization, such as purchase personnel, inventory management personnel, accounting personnel, and so on, to gain access to custom-related data via the network system.

2. Description of Related Art

In the business world of OEM/ODM (Original Equipment Manufacture & Original Design Manufacture), when the manufacturer completes the design and fabrication of customer-ordered products, the manufacturer needs then to carry out a shipment process for transporting the manufactured products to the customer. A shipment process typically includes many standard operational procedures, and of which the custom procedure is the most important for shipment to foreign countries.

Nowadays, most OEM/ODM related enterprises have adopted network-based business management systems, such as ERP (Enterprise Resource Planning) management systems. An ERP management system is an integrated information system developed for use by an enterprise to allow all the departments within the enterprise to share and exchange business information and data, such as status of manufacturing, order entry, accounts receivable and payable, general ledger, purchasing, warehousing, transportation, human resources, and so on, all via a network system, such as the Internet or the enterprise's private intranet or extranet system.

One drawback to the existing ERP management systems, however, is that they are incapable of allowing the working personnel of the enterprise whose responsibilities are related to custom procedures, such as purchase personnel, inventory management personnel, accounting personnel, and so on, to gain access to custom-related data via the enterprise's own ERP management system.

FIG. 1 is a schematic diagram showing a conventional network architecture for an ERP management system 21. As shown, the ERP management system 21 is installed on a business-side server 20 linked to a network system 10, such as the Internet, an intranet system, an extranet system, or a combination thereof, and which is intended for use by all related working personnel of a business organization whose responsibilities are related to custom procedures, such as purchase personnel, inventory management personnel, accounting personnel, and so on, to gain access to ERP management system 21 by means of their workstations 41, 42, 43 and via the network system 10. These personnel can utilize their workstations 41, 42, 43 to log into the ERP management system 21 on the business-side server 20 for the purpose of retrieving related business data from the database 22 of the ERP management system 21. In the network architecture shown in FIG. 1, however, all the custom-related data are stored in the database 32 of a material dispatching management system 31 installed on a data server 30 at the custom service site, and no links are established between the ERP management system 21 and the material dispatching management system 31. For this sake, the personnel of the enterprise are unable to gain access to the custom-related data via their own ERP management system 21. For example, the purchase personnel cannot be informed in real time from the ERP management system about any product items that are near the deadline but haven't yet undergo a custom procedure for shipment to the distributors; and the inventory management personnel cannot be informed in real time from the ERP management system about whether an application to return goods has been approved and executed at the custom service, and therefore has to call by phone to custom officers at the custom service site to inquire about this matter; the accounting personnel cannot gain access to any custom procedure records in the ERP management system to carry out necessary accounting procedures efficiently; to name just a few drawbacks.

One solution to the foregoing problem is to adopt a manual data distribution method, which is carried out by the custom service personnel to utilize his/her workstation 40 at the custom service site to send all related custom procedure data via the network system 10 to the workstations 41, 42, 43 of all the related working personnel of the enterprise. One drawback to this practice, however, is that it is undoubtedly quite tedious, laborious, and timing-consuming and therefore is quite inefficient.

### SUMMARY OF THE INVENTION

It is therefore an objective of this invention to provide a network-based data feedback processing method and system which allows all the related working personnel of an enterprise to gain access to custom-related data that are originally stored on a remote-side server via the enterprise's own ERP management system installed on a local-side server.

It is another objective of this invention to provide a network-based data feedback processing method and system which can help enhance the efficiency of custom-related works in the enterprise.

The network-based data feedback processing method and system according to the invention is designed for use in conjunction with a network system, such as Internet, an intranet system, an extranet system, or a combination thereof, for providing a network-based data feedback processing function that allows all the related working personnel of a business organization, such as purchase personnel, inventory management personnel, accounting personnel, and so on, to gain access to custom-related data via the network system.

The network-based data feedback processing method and system according to the invention is characterized by the capability of feeding the data stored in the database of a material dispatching management system on a data server on a remote side back to an ERP management system on a business-side server on a local side, for the purpose of allowing all the related working personnel of a business organization, such as purchase personnel, inventory management personnel, accounting personnel, and so on, to inquire into the feedback data via their own ERP management system. This feature can help enhance the efficiency of custom-related works in the enterprise.

### BRIEF DESCRIPTION OF DRAWINGS

The invention can be more fully understood by reading the following detailed description of the preferred embodiments, with reference made to the accompanying drawings, wherein:

FIG. 1 is a schematic diagram showing a conventional network architecture for an ERP management system installed on a local side; and

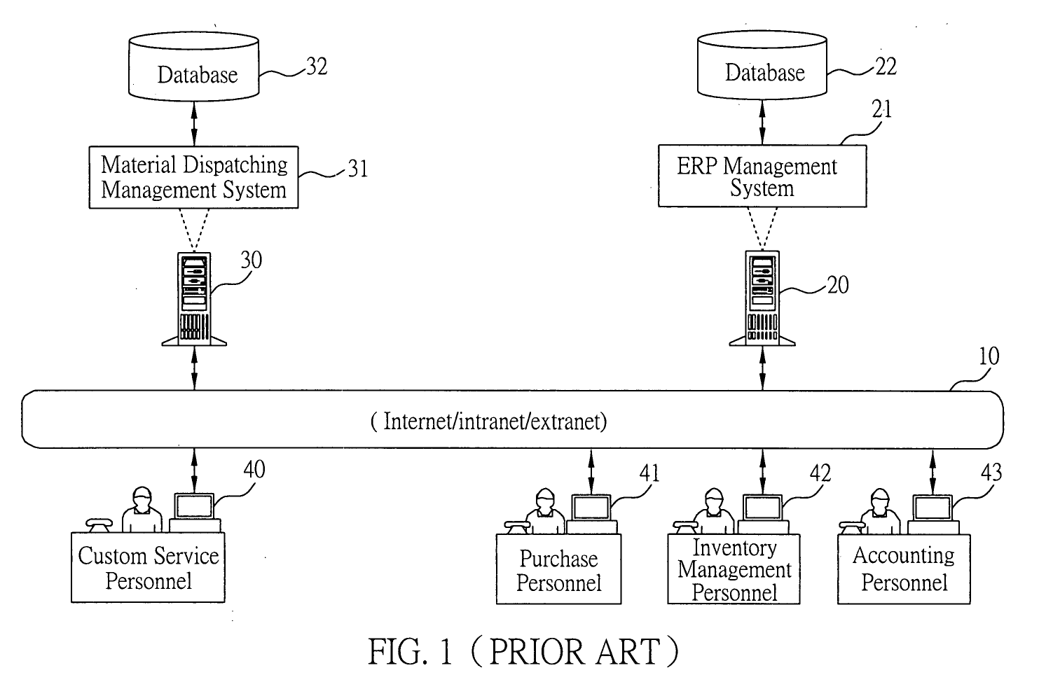

FIG. 2 is a schematic diagram showing the system architecture of the network-based data feedback processing system according to the invention.

### DETAILED DESCRIPTION OF PREFERRED EMBODIMENTS

The network-based data feedback processing method and system according to the invention is disclosed in full details by way of preferred embodiments in the following with reference to the accompanying drawings.

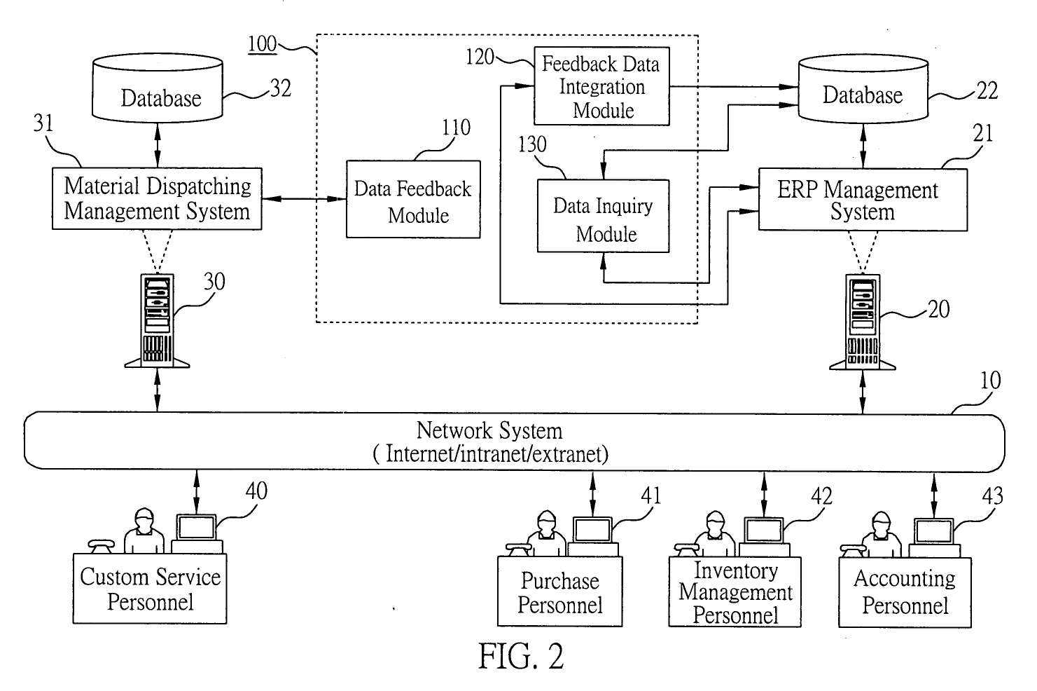

FIG. 2 is a schematic diagram showing the application and distributed system architecture of the network-based data feedback processing system according to the invention (as the part enclosed in the dotted box indicated by the reference numeral 100). As shown, the network-based data feedback processing system of the invention 100 is designed for use in conjunction with a network system 10, such as the Internet, an extranet system, an intranet system, or a combination thereof, where the network system 10 is linked to at least one business-side server 20 at a local side and at least one data server 30 (such as a custom data server installed at a custom service site) at a remote side, and where the business-side server 20 is installed with an ERP (Enterprise Resource Planning) management system 21, such as a SAP-supplied ERP management system, while the data server 30 is installed with a material dispatching management system 31.

In actual applications, the network-based data feedback processing system of the invention 100 is capable of providing a network-based data feedback processing function that allows all the related working personnel of a custom procedure, such as custom service personnel at the custom service site, and purchase personnel, inventory management personnel, accounting personnel, and so on, at the enterprise to share all the custom-related data stored in a database 32 of the material dispatching management system 31 on the data server 30 by means of their workstations 40, 41, 42, 43 and via the network system 10.

As shown in FIG. 2, the network-based data feedback processing system of the invention 100 is based on a distributed architecture whose object-oriented component model comprises: (a) a data feedback module 110; (b) a feedback data integration module 120; and (c) a data inquiry module 130; wherein the data feedback module 110 is integrated to the material dispatching management system 31 on the data server 30 on the remote side, while the feedback data integration module 120 and the data inquiry module 130 are integrated to the ERP management system 21 on the business-side server 20 on the local side.

Firstly, the respective attributes and behaviors of the constituent modules 110, 120, 130 of the network-based data feedback processing system of the invention 100 are described in details in the following.

The data feedback module 110 is integrated to the material dispatching management system 31 on the data server 30 on the remote side (i.e., the custom service site in this example), and which allows the custom service personnel to utilize his/her workstation 40 to operate the material dispatching management system 31 on the data server 30 via the network system 10 for the purpose of feeding a specified set of data stored in the database 32 of the material dispatching management system 31 back via the network system 10 to the ERP management system 21 on the business-side server 20.

The feedback data integration module 120 is integrated to the ERP management system 21 on the business-side server 20 on the local side, and which is capable of integrating the feedback data received by the business-side server 20 via the network system 10 from the data server 30 into a database 22 of the ERP management system 21.

The data inquiry module 130 is integrated to the ERP management system 21 on the business-side server 20, and which is capable of providing a data inquiry function via the network system 10 for all the related working personnel of the enterprise whose responsibilities are related to custom procedures, such as purchase personnel, inventory management personnel, accounting personnel, and so on, to gain access to the feedback data from the data server 30 by means of their workstations 41, 42, 43 and via the network system 10. These personnel can utilize their workstations 41, 42, 43 to log in to the ERP management system 21 on the business-side server 20, and then utilize the data inquiry module 130 to inquire about any information contained in the feedback data now stored in the database 22 of the ERP management system 21 (which were originally stored in the database 32 of the material dispatching management system 31 on the data server 30 on the remote side.

In the following description of an example of a practical application of the invention, it is assumed that the data server 30 is a custom-data server which is installed at a custom service site, and the working personnel of the associated enterprise want to gain access to related custom data via their own ERP management system 21.

Referring to FIG. 2, in actual operation, whenever the material dispatching management system 31 on the data server 30 receives a new set of custom data (i.e., data about a custom procedure filed by the enterprise), the custom service personnel can utilize his/her workstation 40 to operate the material dispatching management system 31 on the data server 30 via the network system 10 for the purpose of feeding the newly-received set of custom data stored in the database 32 of the material dispatching management system 31 back via the network system 10 to the ERP management system 21 on the business-side server 20. When the ERP management system 21 receives the feedback data from the data server 30, the feedback data integration module 120 is automatically activated to integrate the received feedback data into the database 22 of the ERP management system 21. After this, all the related working personnel of the enterprise whose responsibilities are related to the custom procedures, such as purchase personnel, inventory management personnel, accounting personnel, and so on, can gain access to the feedback data stored in the database 22 by means of their workstations 41, 42, 43; i.e., these working personnel can utilize their workstations 41, 42, 43 to log in to the ERP management system 21 on the business-side server 20, and then utilize the data inquiry module 130 to inquire about any information contained in the feedback data which are now stored in the database 22 of the ERP management system 21 on the business-side server 20 at the enterprise site and were previously stored in the database 32 of the material dispatching management system 31 on the data server 30 at the custom service site. For example, the purchase personnel can utilize the T-Code zbs15 specified by the ERP standard to inquire about any product items that are near the deadline but haven't yet undergo a custom procedure for shipment to the distributors so that these product items could be quickly handled to meet the schedule for shipment; and the inventory management personnel can also likewise utilize the T-Code zbs15 to inquire whether an application to return goods has been approved and executed at the custom service site; the accounting personnel can also inquire all custom procedure records in related online reports via the ERP management system 21; to name just a few benefits.

In conclusion, the invention provides a network-based data feedback processing method and system which is designed for use in conjunction with a network system, and which is characterized by the capability of feeding the data stored in the database of a material dispatching management system on a data server on a remote side back to an ERP management system on a business-side server on a local side, for the purpose of allowing all the related working personnel of a business organization, such as purchase personnel, inventory management personnel, accounting personnel, and so on, to inquire into the feedback data via their own ERP management system. This feature can help enhance the efficiency of custom-related works in the enterprise. The invention is therefore more advantageous to use than the prior art.

The invention has been described using exemplary preferred embodiments. However, it is to be understood that the scope of the invention is not limited to the disclosed embodiments. On the contrary, it is intended to cover various modifications and similar arrangements. The scope of the claims, therefore, should be accorded the broadest interpretation so as to encompass all such modifications and similar arrangements.

What is claimed is:

1. A network-based data feedback processing method for use on a network system linked to at least one business-side server on a local side and at least one data server on a remote side, where the business-side server is installed with an ERP management system while the data server is installed with a material dispatching management system, for the purpose of providing a network-based data feedback processing function that allows related working personnel of a business organization to gain access via the ERP management system to the data stored on the business-side server on the remote side via the network system;
the network-based data feedback processing method comprising:
on the remote side, feeding a specified set of data stored in a database of the material dispatching management system on the data server back via the network system to the business-side server;
on the local side, integrating the feedback data received by the business-side server via the network system from the data server into a database of the ERP management system on the business-side server; and
on the local side, performing a data inquiry procedure via the network system by means of a workstation to inquire into the feedback data stored in the database of the ERP management system.

2. The network-based data feedback processing method of claim 1, wherein the network system includes Internet.

3. The network-based data feedback processing method of claim 1, wherein the network system includes an intranet system.

4. The network-based data feedback processing method of claim 1, wherein the network system includes an extranet system.

5. The network-based data feedback processing method of claim 1, wherein the ERP management system on the business-side server is a SAP-supplied ERP management system.

6. The network-based data feedback processing method of claim 1, wherein the data server is a custom-data data server installed at a custom service site.

7. A network-based data feedback processing system for use with a network system linked to at least one business-side server on a local side and at least one data server on a remote side, where the business-side server is installed with an ERP management system while the data server is installed with a material dispatching management system, for the purpose of providing a network-based data feedback processing function that allows related working personnel of a business organization to gain access via the ERP management system to the data stored on the business-side server on the remote side via the network system;
the network-based data feedback processing system comprising:
a data feedback module, which is installed on the data server, and which is capable of feeding a specified set of data stored in a database of the material dispatching management system on the data server back via the network system to the business-side server;
a feedback data integration module, which is installed on the business-side server, and which is capable of integrating the feedback data received by the business-side server via the network system from the data server into a database of the ERP management system on the business-side server; and
a data inquiry module, which is installed on the business-side server, and which is capable of providing a data inquiry function via the network system for related working personnel of the business organization to inquire into the feedback data stored in the database of the ERP management system.

8. The network-based data feedback processing system of claim 7, wherein the network system includes Internet.

9. The network-based data feedback processing system of claim 7, wherein the network system includes an intranet system.

10. The network-based data feedback processing system of claim 7, wherein the network system includes an extranet system.

11. The network-based data feedback processing system of claim 7, wherein the ERP management system on the business-side server is a SAP-supplied ERP management system.

12. The network-based data feedback processing system of claim 7, wherein the data server is a custom-data data server installed at a custom service site.
